(19) United States
(12) Patent Application Publication
(10) Pub. No.: US 2007/0202765 A1
(43) Pub. Date: Aug. 30, 2007

(54) TEXTILE FORM TOUCH SENSOR

(75) Inventors: Jan M. Krans, Den Bosch (NL); Michel P.B. Van Bruggen, Helmond (NL); Galileo J.A. Destura, Eindhoven (NL); Jacob M.J. Den Toonder, Helmond (NL); Johannes T.A. Wilderbeek, Veghel (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,373

(22) PCT Filed: Mar. 24, 2005
(86) PCT No.: PCT/IB05/51013

§ 371 Date: Sep. 27, 2006

(30) Foreign Application Priority Data
Mar. 31, 2004 (GB) 0407366.4

(51) Int. Cl. B32B 27/04; B32B 5/26; B32B 27/12; D03D 15/00

(52) U.S. Cl. 442/301; 442/110; 442/381; 442/268

(57) ABSTRACT

A textile form touch sensor comprises first and second outer conductive layers, and a third layer, intermediate of the first and second layers. The third layer comprises a non-conductive textile coated with a piezoresistive material. In a preferred embodiment, the piezoresistive material is coated on the nonconductive third layer so as to form an arrangement of defined blocks of piezoresistive material, and the first, second and third layers are joined together in a series of straight lines, the lines running in between the defined blocks of piezoresistive material.

This invention relates to a textile form touch sensor and to a method of manufacturing a textile form touch sensor

It is known to provide a touch sensor, such as a button on a flexible keyboard, from a multi-layered textile construction. For example, United States Patent Application Publication US 2002/0180578 discloses a position sensor that is arranged to detect the position of a mechanical interaction such as the application of manual pressure. A first fabric layer has electrically conductive fibers machined therein to provide a first conductive outer layer allowing conduction in all directions along the layer. A second fabric layer has electrically conductive fibers machined therein to provide a second conductive outer layer allowing conduction in all directions along the layer. A central layer is disposed between the first outer layer and the second outer layer. The central layer includes conductive elements. A first insulating separating element is disposed between the first conductive outer layer and the conducting elements. A second insulating separating element is disposed between the second conductive outer layer and the conducting elements. The conducting elements provide a conductive path between the first conducting outer layer and the second conducting outer layer at the position of a mechanical interaction. This five-layered structure measures the position and surface area of the press on the sensor. No direct measurement of the extent of the pressure is possible. The pressure applied by a finger can be deducted from the measured surface area, only for small pressure values

In the same Patent Application Publication, an alternative position sensor is shown in cross-section in FIG. 10. A central layer separates the outer layers, which are of the type described above. The central layer is a felted (non-woven) fabric comprising a mixture of conductive and insulating fibres. The conductive fibres are manufactured to be shorter than the thickness of the central layer and therefore none of the conductive fibres extend completely through the central layer. Furthermore, the ratio of conductive to non-conductive fibres is such that there is no conductive path through the thickness of central layer, or along the central layer, when it is not compressed. Therefore, at locations where no external force is applied to the sensor and the central layer is not compressed, some conductive fibres in the central layer may be in contact with the outer layer but no conductive path exists between the outer layers. When an externally applied force compresses the sensor, the force brings the three layers into intimate contact and conductive fibres in the central layer make electrical contact with the outer conductive layers. In addition, the conductive fibres within the central layer come into contact with other such fibres and thus a conductive path is formed though the central layer between the two outer layers. Furthermore, as the force is increased, the layer is further compressed, the conductive fibres make further connections with other such fibres and the resistance between the outer layer is decreased. If the sensor is folded and produces a localised region of conductivity within the central layer close to its inner surface, the region of conductivity does not extend through the layer and so a conductive path is not formed. This configuration provides a position sensor for detecting the position of an applied mechanical interaction where the mechanical interaction has an area and a force. The three-layered structure measures both the position and the extent of the pressure applied. However—the central layer is uniform throughout and cannot be adjusted to provide different electrical characteristics in different parts of its structure.

A further alternative embodiment is shown in cross-section in FIG. 13. The sensor of this Figure comprises outer layers of the type described above, separated by a central fabric layer. The conductive outer layers are attached by arrays of electrically non-conducting adhesive dots to the central layer. The central layer is manufactured by printing an electrically conductive printable material, such as conductive ink, onto an insulating fabric having an open weave structure, to produce an array of dots (alternatively a knitted fabric, or a non-woven fabric may be used in place of the open structured weave). The ink soaks through the thickness of the fabric to produce an array of conductive islands that provide a conductive path through the thickness of fabric layer. The pattern and spacing of the dots is chosen to be different from the pattern and spacing of the non-conductive islands and so potential problems with Moire effect interference and synchronised overlapping are avoided. Typically, the insulating dots have a spacing of three millimetres whereas the conducting islands have a spacing of 1.3 millimetres. Therefore the sensor, like the previously described sensors, has a structure which allows it to be folded without producing a conductive path between the outer conductive layers at the fold, while at the same time allowing a suitably small externally applied force to bring the outer layers into contact with the central layer, which then provides a conductive path between the outer two layers. This sensor, which has three layers, measures the position and the surface area of the press made upon it, no direct measurement of the extent of the pressure is possible. The structure is also made complicated by the need to space the central layer from the two outer layers, which is achieved by the provision of the non-conducting adhesive dots. This increases the complexity of the device and of its construction.

It is therefore an object of the invention to provide a three-layer touch sensor that is an improvement of the known devices.

According to a first aspect of the invention, there is provided a textile form touch sensor comprising first and second outer conductive layers, and a third layer, intermediate of the first and second layers, wherein the third layer comprises a non-conductive textile coated with a piezoresistive material. The electrical conductance of this piezoresistive material depends on the pressure applied to it.

Owing to this aspect of the invention, it is possible to provide a three-layered textile form touch sensor that can measure position and also the extent of the pressure applied to the touch sensor, while being of simple construction. The resulting sensor is easier to construct than the known sensors.

Advantageously, the piezoresistive material is non-continuous on the non-conductive third layer, and is coated on the non-conductive third layer so as to form an arrangement of defined blocks of the piezoresistive material. The presence of defined blocks of the piezoresistive material on the third layer provides a number of distinct advantages. Each block can be considered as a separate button (in the final construction of the sensor) isolated from each other. This allows the buttons to have different electronic profiles and also allows the layers to be joined together (for instance by stitching) without making an electrical connection at the join of the layers.

Preferably the first, second and third layers are joined together at a point where no piezoresistive material is present. The first, second and third layers are joined together in a series of straight lines, the lines running in between the defined blocks of piezoresistive material. This results in a touch sensor that is more robust than current sensors. The layers are joined together and this helps prevent lateral movement of layers relative to each other. If this occurs (and it is a known problem) then false readings can be given when a user presses the touch pad.

The touch sensor may further comprise a fourth layer, the fourth layer being provided with visible indications. This fourth layer provides a user with a visible indication of the logical function of the sensor at any particular point on the sensor's external surface.

Preferably the touch sensor further comprises two pairs of electrodes, a first pair connected to the first outer layer and a second pair connected to the second outer layer, the pairs of electrodes being perpendicular to each other, and also further comprises electronic circuitry connected to the pairs of electrodes.

According to a second aspect of the invention, there is provided a method of manufacturing a textile form touch sensor comprising the steps of receiving first and second conductive layers, receiving a third layer, the third layer comprising a non-conductive textile coated with a piezoresistive material, and forming the layers such that the third layer is intermediate of the first and second layers.

Owing to this aspect it is possible to manufacture a three-layer textile form touch sensor in a straightforward and simple way.

Advantageously, prior to the receiving of the non-conductive third layer, the method further comprises coating the third layer with the piezoresistive material. The coating of the third layer with the piezoresistive material can be used to create a coating of piezoresistive material on the non-conductive third layer that is non-continuous. Preferably, the coating of the third layer with the piezoresistive material creates a coating of piezoresistive material on the non-conductive third layer that forms an arrangement of defined blocks of piezoresistive material.

Preferably, the method further comprises, prior to the forming of the layers, receiving a fourth layer, the fourth layer being provided with visible indications. The forming of the layers can further comprise joining together the layers at a point where no piezoresistive material is present. Advantageously, the forming of the layers comprises joining together the layers in a series of straight lines, the lines running in between the defined blocks of piezoresistive material.

The method can further comprise affixing two pairs of electrodes to the layers, a first pair connected to the first outer layer and a second pair connected to the second outer layer, the pairs of electrodes being perpendicular to each other, and can also further comprise connecting electronic circuitry to the pairs of electrodes.

Embodiments of the present invention will now be described, by way of example only, with reference to the accompanying drawings, in which:—

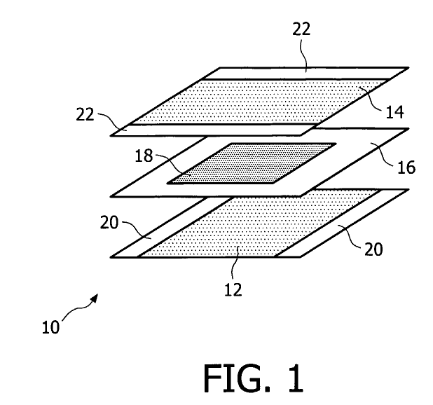

FIG. 1 is a schematic view of a three-layer textile form touch sensor,

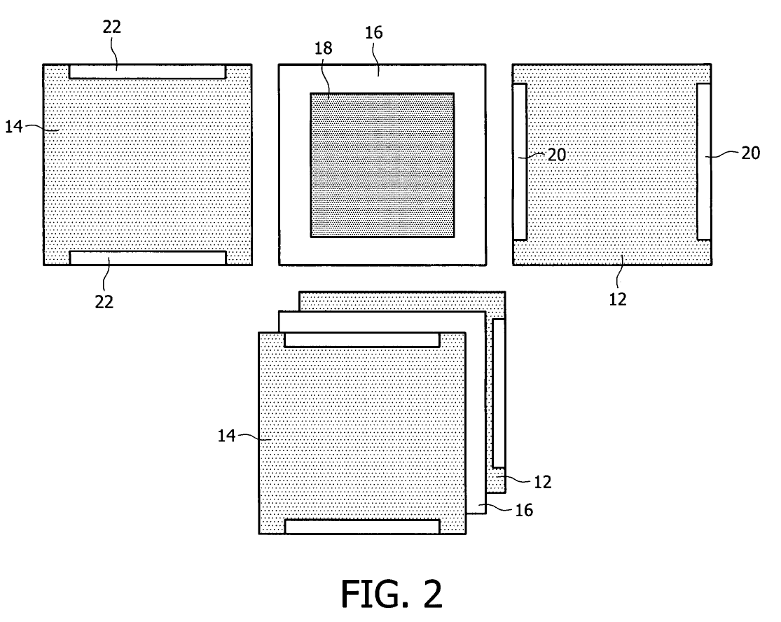

FIG. 2 is a schematic view of the three-layer textile form touch sensor of FIG. 1, also showing each individual layer,

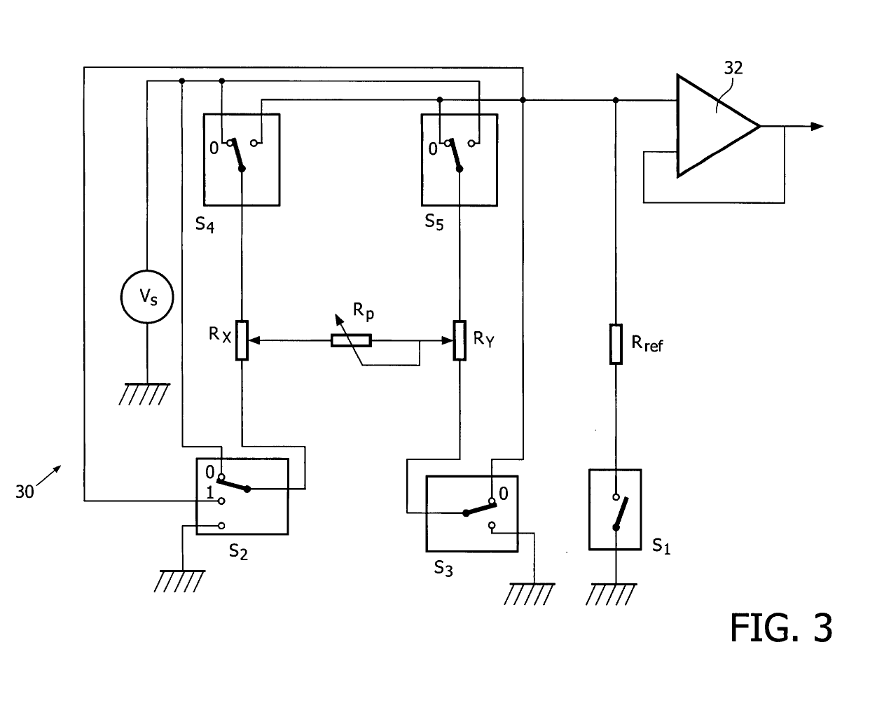

FIG. 3 is a diagram of electronic circuitry,

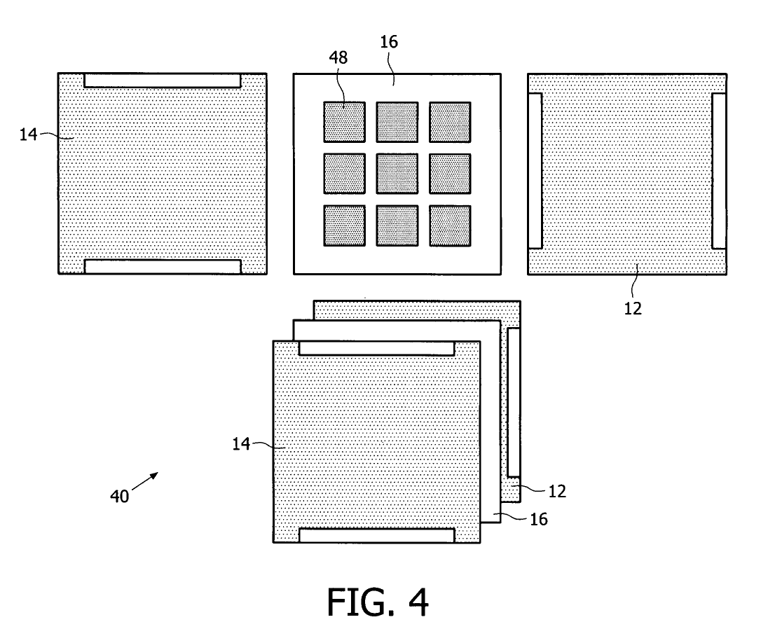

FIG. 4 is a schematic view similar to FIG. 2 of a second embodiment of the three-layer textile form touch sensor,

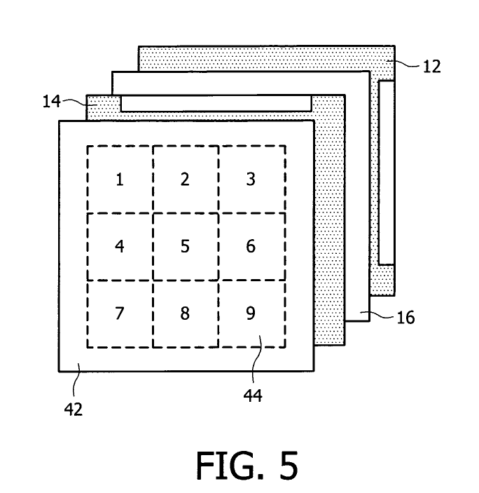

FIG. 5 is a schematic view of the textile form touch sensor of FIG. 4, with an additional fourth layer,

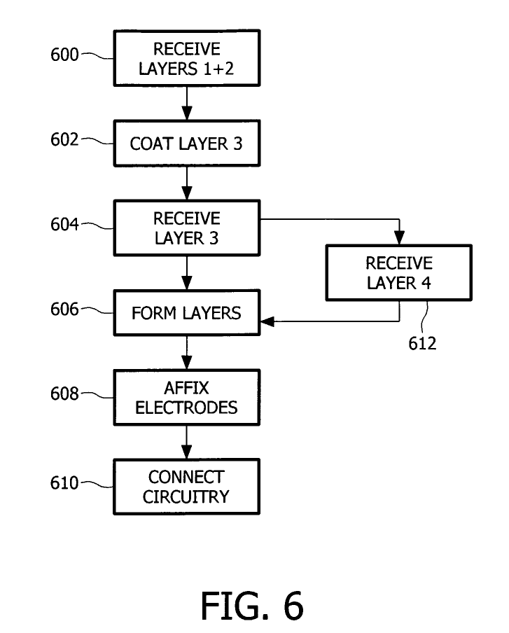

FIG. 6 is a flow diagram of a method of manufacturing the textile form touch sensor, and

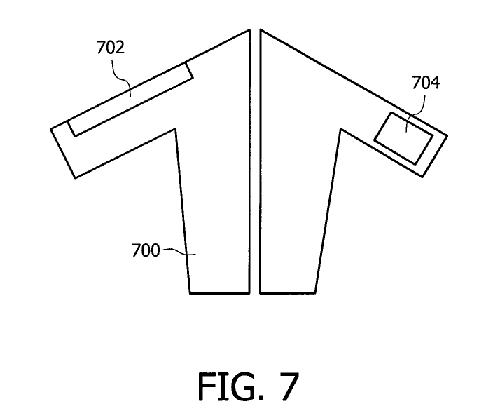

FIG. 7 is a schematic diagram of two textile form touch sensors on a garment.

FIGS. 1 and 2 show a first embodiment of the three-layer textile form touch sensor. The textile form touch sensor 10 comprises first and second outer conductive layers 12 and 14 respectively, and a third layer 16, which is intermediate of the first and second layers 12 and 14. The third layer 16 comprises a non-conductive textile coated with a piezoresistive material 18. The outer layers 12 and 14 are constructed from a conductive fabric such as woven polyester coated with polypyrrole, commercially available as Contex fabrics from Marktek Inc. The third intermediate layer 16 is formed by piezoresistive ink 18 being coated on a non-conducting textile 16. Any conventional non-conductive textile such as woven polyester can be used as the substrate for the layer 16, provided that the ink can soak through the entire thickness of the textile. The pressure sensitive ink 18, in this preferred embodiment, is the substance described in WO 97/25379 and commercially available from Tekscan Inc. (see website www.tekscan.com). Other piezoresistive material with the required electrical, chemical and mechanical properties can be employed. The conductance of the printed textile layer 16 is zero at zero load, but increases strongly when a load larger than the threshold load is applied.

The structure shown in FIGS. 1 and 2 is a touch sensor 10 that in its normal state does not conduct between the two outer layers 12 and 14, as the third layer 16 creates an insulating layer between the two outer layers 12 and 14. However, if the user presses on the outer layer 14 (for example, when the sensor is installed as a volume control in a garment such as a jacket), this applied force changes the resistive characteristic of the piezoresistive material 18. The material 18 becomes conductive to an extent that is proportional to the force applied to it by the user and thus current can flow between the layers 14 and 12.

The sensor 10 further comprises two pairs of electrodes, a first pair 20 connected to the first outer layer 12 and a second pair 22 connected to the second outer layer 14, the pairs of electrodes 20 and 22 being perpendicular to each other. The touch sensor also comprises electronic circuitry 30 connected to the pairs of electrodes 20 and 22.

The circuitry 30 is shown in detail in FIG. 3 and comprises a variable resistor Rₚ, which is the piezoresistive material 18 coated on the middle layer 16, two resistors Rₓ and R_{y}, which are the resistances of the outer layers 12 and 14 respectively, a reference resistor R_{ref}, a voltage source Vₛ, a high impedance readout buffer 32, and five switches S1 to S5. The circuitry 30 measures three different things, the users pressure on the touch sensor, and the x and y positions of that press. Which of these three things is measured depends upon the position of the five switches S1 to S5. The switches are controlled to cycle quickly through the positions, thereby obtaining readings for the three things to be measured in a short space of time. The following table defines the position of each switch depending upon what is being measured:

| Mode | S1 | S2 | S3 | S4 | S5 |
|---|---|---|---|---|---|
| Touch/Pressure | 1 | 0 | 0 | 0 | 0 |
| X coordinate | 0 | 2 | 0 | 0 | 0 |
| Y coordinate | 0 | 1 | 1 | 1 | 1 |

Rₓ and R_{y} are the resistances of the top and bottom conducting layers 12 and 14. Rₚ is the variable resistance of the third layer 16 printed with the Tekscan 18. R_{ref} is used both to detect the presence of a touch action as well as the exerted touch pressure. In effect when the variable resistance of the press is measured, the layers 12 and 14 (the resistors Rₓ and R_{y}) are at constant potential across their whole surface area and the circuit created is a potential divide with Rₚ and R_{ref} with the buffer 32 reading the voltage at the point between Rₚ and R_{ref}, thereby measuring the resistance of Rₚ (since R_{ref} is known). The resistance of Rₚ is a measure of the extent of the press by the user on the touch sensor 10.

During the x position detection, a linear potential drop across the conducting layer Rx is applied. A potential probe consists of the electrical series configuration of part of R_{y} and Rₚ. However, the probe's resistance becomes irrelevant in reading the x-coordinate as a high impedance readout buffer is used. The same holds when determining the y coordinate. In effect the Rₚ as it touches the resistor Rₓ (when measuring the x coordinate) measures the voltage at that point, effectively measuring the position of the press on the touch sensor in the x direction. This is reversed when measuring the y coordinate.

FIG. 4 shows a second embodiment 40 of the touch sensor. This textile form touch sensor 40 (as in the first embodiment) comprises first and second outer conductive layers 12 and 14 respectively, and a third layer 16, which is intermediate of the first and second layers 12 and 14. The third layer 16 comprises a non-conductive textile coated with a piezoresistive material 48. The piezoresistive material 48 is non-continuous on the non-conductive third layer 16. This layer of piezoresistive material 48 is coated on the non-conductive third layer 16 so as to form an arrangement of defined blocks of piezoresistive material 48.

As the piezoresistive material 48 is arranged in a series of blocks on the third layer 16, this allows the first, second and third layers 12, 14 and 16 to be joined together at a point where no piezoresistive material 48 is present. The first, second and third layers 12, 14 and 16 are joined together in a series of straight lines, the lines running in between the defined blocks of piezoresistive material 48. By joining together the layers a more stable structure is present and it also greatly reduces the likelihood of a false reading caused by the folding of the sensor when in use.

In FIG. 5, the touch pad 40 further comprises a fourth cover layer 42; the fourth layer 42 being provided with visible indications 44. In this example, the visible indications 44 are the numerals 1 to 9, and to the user they represent nine different buttons to be pressed, which correspond to the blocks of piezoresistive material 48 on the third layer 16. Note that a fifth cover layer could be applied to the back of the pad as well.

FIG. 6 is a flow diagram of the method of manufacturing the textile form touch sensor 10. The method of manufacturing the textile form touch sensor 10 in its simplest form comprises the steps of receiving 600 the first and second conductive layers 12 and 14, receiving 604 the third layer 16, the third layer 16 comprising a non-conductive textile coated with a piezoresistive material 18, and forming 606 the layers such that the third layer 16 is intermediate of the first and second layers 12 and 14.

In this basic version of the method of constructing the touch sensor 10, the third layer 16 is provided already coated with the piezoresistive material 18. However the method can further comprise, prior to the receiving 604 of the non-conductive third layer 16, the step 602 of coating the third layer 16 with the piezoresistive material 18. By including within the method of constructing the touch sensor the step 602 of coating the third layer 16, greater flexibility is achieved in choosing the possible arrangements of coatings of the piezoresistive material 18.

For example, the coating 602 of the third layer 16 with the piezoresistive material can be used to create a coating of piezoresistive material on the non-conductive third layer 16 that is non-continuous. Such an arrangement is shown in FIG. 4 and described above in more detail. The non-continuous arrangement could be such that the coating 602 of the third layer 16 with the piezoresistive material 48 creates a coating of piezoresistive material 48 on the non-conductive third layer 16 that forms an arrangement of defined blocks of piezoresistive material 48.

The method also includes the optional step 612 which means that the method of manufacture further comprises, prior to the forming 606 of the layers, receiving 612 a fourth layer 42, the fourth layer 42 being provided with visible indications 44. The step 606, which is the forming of the layers together to produce the body of the touch sensor 10, can also comprise joining together the layers 12, 14 and 16 at a point where no piezoresistive material 18 is present. In a preferred embodiment, as shown in FIG. 5, the forming 606 of the layers comprises joining together the layers in a series of straight lines, the lines running in between the defined blocks of piezoresistive material 18.

Following the forming 606 of the layers the method further comprises affixing two pairs of electrodes 20 and 22 to the layers 12 and 14 respectively, a first pair 20 connected to the first outer layer 12 and a second pair 22 connected to the second outer layer 14, the pairs of electrodes being perpendicular to each other. The method also further comprises connecting electronic circuitry 30 to the pairs of electrodes 20 and 22.

Once the touch pad sensor 10 is formed, it can be integrated in a wide range of fabrics, such as used in clothing or furniture. The following applications are appropriate uses of the sensor, a light dimmer/switch in wallpaper; a weight sensor in chair, sofa, mattress or bath mat; an interactive gaming playmat or wall hanging; a guidance or security carpet detecting the location of people walking on it, a fabric piano with force sensitivity; a touch panel in a sofa or in a blanket (home, automotive) to control ambient electronics and/or chair position; a shoe insole that analyses walking/running pattern; and the touch screen of a fabric display (a fabric display put on top of a fabric touch pad).

One such application is illustrated in FIG. 7, which shows two examples of the touch sensor in use on a jacket 700. The first sensor 702 covering one of the sleeves would typically be used as a position sensitive volume control strip, being connected to an MP3 player. The second sensor pad 704 could be used as a touch pad to write text messages. This latter application does require an additional feedback mechanism (audio or visual), which is not shown.

In summary, in comparison with the known prior art, the following problems are solved. Load sensitive material is not applied as a sheet of load-sensitive non-woven or a sheet of load sensitive elastomer but can be locally printed in any desired shape or structure. The threshold load needed to obtain a conductance larger than zero can be determined by the fraction of conducting particles present in the ink. The slope of the conductance versus the load, i.e. the load sensitivity of the pad is also dependent on the filling fraction of conducting particles in the ink. Due to the freedom opened up by printing, the textiles can be sewn to each other, avoiding sliding of the layers (sliding leads to the need for re-calibration). No spacers are needed and the material can be folded without the occurrence of false signals. The composite is fully textile with an open structure so that the natural breathing character of textiles is maintained.

1. A textile form touch sensor comprising first and second outer conductive layers (12, 14), and a third layer (16), intermediate of the first and second layers (12, 14), wherein the third layer (16) comprises a non-conductive textile coated with a piezoresistive material (18; 48).

2. A touch sensor according to claim 1, wherein the piezoresistive material (48) is non-continuous on the non-conductive third layer (16).

3. A touch sensor according to claim 2, wherein the piezoresistive material (48) is coated on the non-conductive third layer (16) so as to form an arrangement of defined blocks of piezoresistive material (48).

4. A touch sensor according to claim 3, wherein the first, second and third layers (12, 14, 16) are joined together at a point where no piezoresistive material (48) is present.

5. A touch sensor according to claim 4, wherein the first, second and third layers (12, 14, 16) are joined together in a series of straight lines, the lines running in between the defined blocks of piezoresistive material (48).

6. A touch sensor according to claim 1, and further comprising a fourth layer (42), the fourth layer (42) being provided with visible indications (44).

7. A touch sensor according to claim 1, and further comprising two pairs of electrodes (20, 22), a first pair (20) connected to the first outer layer (12) and a second pair (22) connected to the second outer layer (14), the pairs of electrodes (20, 22) being perpendicular to each other.

8. A touch sensor according to claim 7, and further comprising electronic circuitry (30) connected to the pairs of electrodes (20, 22).

9. A method of manufacturing a textile form touch sensor comprising the steps of receiving (600) first and second conductive layers (12, 14), receiving (604) a third layer (16), the third layer (16) comprising a non-conductive textile coated with a piezoresistive material (18; 48), and forming (606) the layers such that the third layer (16) is intermediate of the first and second layers (12, 14).

10. A method according to claim 9, and further comprising, prior to the receiving (604) of the non-conductive third layer (16), coating (602) the third layer (16) with the piezoresistive material (18; 48).

11. A method according to claim 10, wherein the coating (602) of the third layer (16) with the piezoresistive material (48) creates a coating of piezoresistive material (48) on the non-conductive third layer (16) that is non-continuous.

12. A method according to claim 11, wherein the coating (602) of the third layer (16) with the piezoresistive material (48) creates a coating of piezoresistive material (48) on the non-conductive third layer (16) that forms an arrangement of defined blocks of piezoresistive material (48).

13. A method according to claim 9, and further comprising, prior to the forming (606) of the layers, receiving (612) a fourth layer (42), the fourth layer (42) being provided with visible indications (44).

14. A method according to claim 12, wherein the forming (606) of the layers comprises joining together the layers at a point where no piezoresistive material (48) is present.

15. A method according to claim 14, wherein the forming (606) of the layers comprises joining together the layers in a series of straight lines, the lines running in between the defined blocks of piezoresistive material (48).

16. A method according to claim 9, and further comprising affixing (608) two pairs of electrodes (20, 22) to the layers, a first pair (20) connected to the first outer layer (12) and a second pair (22) connected to the second outer layer (14), the pairs of electrodes (20, 22) being perpendicular to each other.

17. A method according to claim 16, and further comprising connecting (610) electronic circuitry (30) to the pairs of electrodes (20, 22).
